(19) United States
(12) Patent Application Publication
(10) Pub. No.: US 2025/0320638 A1
(43) Pub. Date: Oct. 16, 2025

(54) PAPER MACHINE CLOTHING

(71) Applicant: VOITH PATENT GMBH, Heidenheim (DE)

(72) Inventors: Robert EBERHARDT, Ellwangen (DE); Susanne KLASCHKA, Köln (DE)

(21) Appl. No.: 19/245,948

(22) Filed: Jun. 23, 2025

Related U.S. Application Data
(63) Continuation of application No. PCT/EP2023/086013, filed on Dec. 15, 2023.

(30) Foreign Application Priority Data
Dec. 21, 2022 (DE) 10 2022 134 270.0

(51) Int. Cl. D03D 3/04; B32B 1/08; B32B 5/02; B32B 5/06; B32B 5/26; D03D 11/00; D03D 15/33; D04H 1/46; D21F 1/00

(52) U.S. Cl. CPC D03D 3/04; B32B 1/08; B32B 5/022; B32B 5/024; B32B 5/06; B32B 5/263; B32B 5/275; D03D 11/00; D03D 15/33; D04H 1/46; D21F 1/0027; B32B 2250/20; B32B 2262/02; B32B 2413/00; D10B 2505/00

(57) ABSTRACT

A paper machine clothing, such as a press felt for a machine for producing or processing a pulp web, has a base structure. The base structure has a first woven-fabric layer and a second woven-fabric layer which are arranged one above the other and each having threads in the machine direction (MD) and threads in the cross-machine direction (CD). Both the first woven-fabric layer and the second woven-fabric layer include threads which are in the form of monofilaments and threads that are in the form of twisted threads.

### CROSS-REFERENCE TO RELATED APPLICATION

This application is a continuation, under 35 U.S.C. §120, of copending International Patent Application PCT/EP2023/086013, filed Dec. 15, 2023, which designated the United States; this application also claims the priority, under 35 U.S.C. § 119, of German Patent Application DE 10 2022 134 270.0, filed Dec. 21, 2022; the prior applications are herewith incorporated by reference in their entirety.

### FIELD AND BACKGROUND OF THE INVENTION

The invention relates to paper machine clothing, in particular to a press felt for a machine for producing or processing a pulp web. The paper machine clothing comprises a base structure which has a first woven-fabric layer and a second woven-fabric layer which are arranged one above the other and each of which comprises threads in the machine direction (MD) and threads in the cross-machine direction (CD).

Clothings, in particular paper machine clothings, frequently have one or more woven-fabric layers as a constituent of a base structure. To be utilized in a paper machine clothing, continuous woven-fabric layers, known as tape loops, are usually needed.

These may either be woven directly as a tape loop (“circular-woven”), or they may be woven as a flat piece of woven fabric which is rendered continuous by connecting the two front ends.

Various possibilities for such a connection of two ends of a flat-woven fabric are known from the prior art. For example, US 2014/0186579 describes connecting two ends by means of an ultrasonic weld seam. Alternatively, the connection may also be effected, for example, by means of laser welding.

Published documents EP 3960932 A1 and WO 2022/089843 A1 describe that several of such woven-fabric layers may be arranged one above the other to create a multi-layer base structure.

In this regard, the two cited documents address the connecting points of the front ends which have been identified to be potential defects in the base structure. In this regard, the design of the connections and their relative positions with respect to one another are optimized.

Yet, moreover, it is desirable to further optimize the performance of the entire base structure. In particular, it would be desirable to improve the shrinkage behavior of the base structure. Also, improved fiber anchoring of the non-woven fibers over the entire surface area of the paper machine clothing is desirable as well.

### SUMMARY OF THE INVENTION

It is accordingly an object of the invention to provide a paper machine clothing which overcomes the above-mentioned disadvantages of the heretofore-known devices and methods of this general type, yet which provides for such a paper machine clothing that is as simple and inexpensive as possible to produce.

With the above and other objects in view there is provided, in accordance with the invention, a paper machine clothing, comprising:

a base structure having a first woven-fabric layer and a second woven-fabric layer arranged one above another;

each of said first and second woven-fabric layers having threads in a machine direction (MD) and threads in a cross-machine direction (CD); and

each of said first and second woven-fabric layers having threads being monofilaments and threads being twisted threads.

In other words, the novel paper machine clothing may be formed as a press felt for a machine for producing or processing a pulp web. The paper machine clothing comprises a base structure which has a first woven-fabric layer and a second woven-fabric layer which are arranged one above the other and each of which has threads in the machine direction (MD threads) and threads in the cross-machine direction (CD threads).

In this regard, both the first woven-fabric layer and the second woven-fabric layer comprise threads which are in the form of monofilaments and threads which are in the form of twisted threads.

In this regard, paper machine clothings according to aspects of the invention may be realized in various ways and comprise a plurality of advantages.

### Variant 1: Continuous Structure

In this variant, the first woven-fabric layer consists of a first flat-woven fabric which is rendered continuous, in particular, by connecting its front edges. The second woven-fabric layer consists of a second flat-woven fabric which is also rendered continuous, in particular, by connecting its front edges.

Such a base structure, or such a paper machine clothing, is referred to as “continuous” to distinguish it from paper machine clothings comprising seam loops and may only be brought into a continuous configuration by closing this seam by means of a pintle wire.

In this regard, it may be provided that both the first flat-woven fabric and the second flat-woven fabric comprise CD threads which are in the form of monofilaments, and both the first flat-woven fabric and the second flat-woven fabric comprise CD threads which are in the form of twisted threads.

Such paper machine clothings may be in such a form that the ratio of twisted threads to monofilaments (twist-to-mono ratio) of the first flat-woven fabric differs from the twist-to-mono ratio of the second flat-woven fabric.

Alternatively or additionally, such paper machine clothings may also be in such a form that the CD thread densities of the first woven-fabric layer and of the second woven-fabric layer are different.

CD threads refer to those threads of the woven fabric which are oriented completely or substantially in the cross-machine direction (“CD”) when the paper machine clothing is used as intended.

MD threads refer to those threads of the woven fabric which are oriented completely or substantially in the machine direction (“MD”) when the paper machine clothing is used as intended.

The inventors have recognized that providing twisted threads in the woven-fabric layers has a positive effect on the fiber anchoring of the non-woven fibers in the subsequent needling process.

By adapting the ratio of twisted threads and monofilaments, the shrinkage behavior may be influenced.

In the case of paper machine clothings according to an aspect of the invention, the twist-to-mono ratio in the first woven-fabric layer differs from that in the second woven-fabric layer.

To be able to ensure the production of such paper machine clothings in an economically sensible manner, it is important that the first and second woven-fabric layers are in the form of flat-woven fabrics which have been rendered continuous. More precisely, in such woven fabrics, the CD threads are the weft threads of the weaving process, while the MD threads result from the warp threads. Switching a warp system of a loom is a very complex activity and requires a long standstill of the loom. Switching the weft threads, by contrast, is possible in a comparatively simple manner.

Thus, in the flat-woven fabrics of the first and second woven-fabric layers, the twist-to-mono ratios may be adapted in a very simple and economical manner. In particular, it is even possible to weave the two flat-woven fabrics directly one after the other on the same loom. When adjusting the weft thread pattern, only a very short standstill period arises.

Instead of changing the twist-to-mono ratio, or in addition thereto, the CD thread densities of the first woven-fabric layer and of the second woven-fabric layer may also be different.

In this regard, the thread density is defined as the number of threads per unit of length.

In this regard, the thread density of the first CD threads may be between 20 and 200 threads/10 cm, preferably between 50 and 100 threads/10 cm.

In advantageous embodiments, it may be provided that the CD thread density of the second woven-fabric layer is between 3% and 80%, in particular between 5% and 60%, greater than the CD thread density of the first woven-fabric layer.

A further advantage of the different thread densities of the two layers is that the Moiré effect may be suppressed thereby. In this regard, a difference of less than 3% often does not ensure sufficient suppression of the Moiré effect.

In particular, it may be provided that the first woven-fabric layer is arranged above the second woven-fabric layer and in particular constitutes the uppermost woven-fabric layer of the base structure.

The base structure may also have further layers, in particular further woven-fabric layers. Alternatively, the base structure may consist only of the first woven-fabric layer (1) and the second woven-fabric layer (2).

In advantageous embodiments, it may be provided that the twist-to-mono ratio of the first flat-woven fabric is between 1:3 and 3:1. Preferably, the proportion of the twisted CD threads of the first flat-woven fabric may be greater than that of the monofilaments. More preferably, the twist-to-mono ratio of the first flat-woven fabric may be between 1:1 and 2:1.

It may be provided that the twist-to-mono ratio of the second flat-woven fabric is less than the twist-to-mono ratio of the first flat-woven fabric. Preferably, the proportion of the twisted CD threads of the second flat-woven fabric may be less than that of the monofilaments.

In particular, it may be provided that the twist-to-mono ratio of the second flat-woven fabric is between 1:4 and 1:1.

In principle, regular or non-regular sequences of monofilaments and twists may be provided. Sequences with longer repeat units or quasi-statistical sequences of monofilaments and twists may be provided. Such deviations from the strict regularity may have an advantageous effect on the running behavior of the paper machine clothing since, for example, vibrations generated cannot build up so easily (avoidance of resonance).

The monofilaments used may comprise diameters between 0.2 mm and 0.8 mm, preferably between 0.3 mm and 0.6 mm.

The twists may consist of 2 to 9 individual threads; preferably of 3 or 4 individual threads.

The same or different monofilaments may be used in the first flat-woven fabric and in the second flat-woven fabric. In particular, the monofilaments may comprise the same or different diameters.

For example, it may be advantageous if the second woven-fabric layer is arranged below the first woven-fabric layer, and the monofilaments of the second woven-fabric layer have a larger diameter than the monofilaments of the first woven-fabric layer.

A plurality of structures are possible for the MD threads of the two woven-fabric layers.

Although the MD threads may also be in the form of twists, it is often advantageous if all of the MD threads of the two woven-fabric layers are in the form of filaments.

The MD threads of the first woven-fabric layer and/or of the second woven-fabric layer may in particular comprise a diameter between 0.2 mm and 1 mm.

The MD thread densities of the first woven-fabric layer and/or of the second woven-fabric layer may be between 20 and 200 threads per 10 cm.

In this regard, it may be provided that the first woven-fabric layer and the second woven-fabric layer comprise the same MD threads or at least the MD threads which comprise substantially the same thread cross-section.

In advantageous embodiments, it may be provided that the diameter of the MD threads of the first woven-fabric layer and/or of the second woven-fabric layer is between 0.24 mm and 0.6 mm, preferably between 0.3 mm and 0.5 mm.

A two-layer base structure, in contrast to single-layer structures, involves the advantage that the MD threads of both layers contribute to absorbing tensile forces in the MD direction. Thereby, the MD threads of the individual layers may be maintained thinner, and may in particular comprise diameters of 0.6 mm, 0.5 mm or less. Furthermore, in the case of MD threads with diameters above 0.6 mm, the base structure is imparted greater stiffness, which makes handling the structure during further working, e.g., into a felt, and during later utilization more difficult.

The first woven-fabric layer and the second woven-fabric layer may comprise the same or different MD threads.

The CD thread densities of the first woven-fabric layer and of the second woven-fabric layer may be the same or may be different.

The first woven-fabric layer and the second woven-fabric layer may be arranged such that the connection point of the front edges of the first flat-woven fabric and the connection point of the front edges of the second flat-woven fabric, viewed in the machine direction, comprise a distance of at least 10 cm, in particular at least 1 m, and preferably a distance of at most 3 m.

Alternatively or additionally, it may be provided that the connection(s) of the front edges of the first flat-woven fabric and/or of the second flat-woven fabric is or are in the form of a welded connection, in particular of a laser-welded connection.

Thus, in a paper machine clothing according to aspects of the present invention, the features described as advantageous in the above-mentioned prior art documents EP3960932 A1 and WO 2022/089843 A1 may also be realized.

Usually, the paper machine clothing will also have one or more layers of non-woven fibers, which may be arranged in particular on the top side of the base structure. Alternatively or additionally, one or more layers of non-woven fibers may also be provided on the bottom side of the base structure.

Usually, the non-woven fibers are connected to the base structure, for example by mechanical needling. In this regard, the non-woven fibers also penetrate the base structure completely or partially, or may even pass through it.

In advantageous embodiments, it may be provided that at least some of the non-woven fibers consist of or have a thermoplastic polymer. A thermoplastic polyurethane (TPU) has proven to be very advantageous herein.

The non-woven fibers may consist of staple fibers comprising a linear density of between 1.5 dtex and 300 dtex, in particular between 6.7 and 200 dtex.

### Variant 2: Hybrid Structure

In this variant, the first woven-fabric layer is formed of a continuously woven circular-woven fabric, and the second woven-fabric layer is formed of a flat-woven fabric which is rendered continuous, in particular, by connecting its front edges, wherein the first woven-fabric layer comprises twisted MD threads, while the second woven-fabric layer comprises twisted CD threads.

In this regard, the connection of the front edges may be realized by a material-fit connection, for example a welded connection. In particular, transmission welding, e.g., NIR transmission welding, is a very advantageous joining method for this purpose. Alternatively, the welded connection may also be realized by means of ultrasonic welding.

The base structure described may be referred to as a hybrid base structure since it comprises both a circular-woven fabric and a flat-woven fabric. Hence, it is faster and economically more favorable to produce than a base structure made of two circular-woven fabrics. On the other hand, sufficient tensile strength is significantly easier to achieve with the hybrid base structure than it is with base structures which, as shown in EP 3 960 932 A1, are composed exclusively of flat-woven fabrics.

A further advantage of the hybrid structure is that, by combining a single type of circular-woven fabric with various flat-woven fabric structures, a plurality of base structures may be produced and may be adapted to a wide variety of requirements. Thus, it is not necessary to have to stock many different types of circular-woven fabrics, but only a few types of circular-woven fabrics, or even only one type of circular-woven fabric, will suffice.

For the flat-woven fabric and the circular-woven fabric, various types of woven fabrics or weaving patterns may be used.

It is particularly advantageous if the flat-woven fabric comprises a plain weave since this is very quick and inexpensive to produce.

The circular-woven fabric may also comprise a plain weave.

Flat-woven fabrics and circular-woven fabrics may comprise the same weaving structure.

Flat-woven fabrics and circular-woven fabrics may comprise different weaving structures. In this regard, they may differ in weaving patterns, thread types, thread densities, thread materials, etc.

The kinds of threads the woven fabrics are composed of may be selected depending on the desired properties or the conditions of utilization of the paper machine clothing. For example, to improve the fiber anchoring of a non-woven layer, it may be advantageous if some of the woven fabric threads are in the form of twisted threads.

In a more preferable embodiment, it may be provided that the first woven-fabric layer comprises twisted MD threads, while the second woven-fabric layer comprises twisted CD threads.

In this embodiment, a further great benefit of the hybrid base structure becomes evident. More precisely, when used as a base woven fabric, the circular-woven fabrics are used rotated 90° compared to the weaving direction. This means that the warp threads of the circular-woven fabric become CD threads of the paper machine clothing, while the weft threads of the circular-woven fabric become MD threads of the paper machine clothing.

In flat-woven fabrics, this rotation does not take place. Thus, the warp threads of the flat-woven fabric are the MD threads, and the weft threads are the CD threads.

By using a hybrid base structure, it is hence possible for the base structure to have twisted threads both in the MD direction and in the CD direction, without it being necessary to use twisted warp threads during weaving.

This is particularly advantageous also because switching a warp system on a loom is very time-consuming. In particular for smaller production quantities, altering the warp system is not economically sensible. In comparison, switching the weft threads is very easy to realize. Thus, by means of the hybrid base structure, paper machine clothings are possible which are not sensibly to produce with exclusively circular-woven fabrics nor with exclusively flat-woven fabrics.

In an advantageous embodiment, it may be provided that in the first woven-fabric layer, at least 50%, preferably at least 75%, in particular all of the MD threads, are twisted MD threads.

In a further advantageous embodiment, it may be provided that in the second woven-fabric layer, at least 30% of the CD threads are twisted CD threads.

Preferably, in the second woven-fabric layer, 50% of the CD threads may be twisted CD threads, wherein twisted CD threads and non-twisted CD threads are arranged alternately. However, other ratios between twisted and non-twisted threads may also be provided, for instance 1:2; 2:1; 3:1; 2:3, or 3:2.

It is possible that the same twists are used for the twisted MD threads as for the twisted CD threads. Alternatively, it is also possible that different twists are used for the twisted MD threads and the twisted CD threads.

It is also possible that the same twists are always used within a woven-fabric layer, or that different twists are used within a woven-fabric layer.

The non-twisted MD and/or CD threads may comprise a diameter of 0.2 mm to 0.8 mm, in particular of 0.25 mm-0.6 mm.

In further advantageous embodiments, it may be provided that some or all of the twisted MD threads and/or of the twisted CD threads consist of three or more monofilaments.

In this regard, the monofilaments may in particular comprise a diameter of more than 0.1 mm, in particular between 0.15 mm and 0.6 mm; preferably between 0.2 mm and 0.25 mm.

Suitable twists are, for example, 0.2×2×2 (4-ply) and 0.25×2×2 (4-ply). The twists often consist of a polyamide material but may also be made of other polymers.

The non-twisted CD threads may comprise a diameter of 0.2 mm to 0.8 mm, in particular of 0.25 mm-0.6 mm.

It is often expedient if the first woven-fabric layer is arranged closer to the web-contacting surface of the paper machine clothing than the second woven-fabric layer. This reduces the risk of marks arising in the pulp web due to the connection point of the front edges of the flat-woven fabric. Any irregularities of the second woven-fabric layer at this point may be attenuated by the first woven-fabric layer.

Alternatively, it may also be provided that the second woven-fabric layer is arranged closer to the web-contacting surface of the paper machine clothing than the first woven-fabric layer. This may be advantageous, for example, if the running side of the paper machine clothing is exposed to severe wear and abrasion in the intended installation position. In this case, a circular-woven fabric may comprise better wear resistance than the second woven-fabric layer, as appropriate. This may be the case, for example, if the front edges are connected to one another by an ultrasonic weld connection, which may also become brittle over time under heavy load.

The hybrid base structure according to aspects of the invention may comprise further constituents other than the first and second woven-fabric layers. In particular, further woven-fabric layers may be provided, namely circular-woven fabrics and/or flat-woven fabrics.

Alternatively or additionally, the base structure may also comprise constituents that have not been woven, such as, for example, non-woven layers, films, membranes, foam layers, or the like.

It is advantageous, in particular with regard to the costs and the time expenditure during production, if the base structure does not have any further woven-fabric layer.

In particular for use as a press felt, it will typically be provided that the paper machine clothing comprises at least one non-woven layer which is fastened to the base structure, in particular by needling, and which makes the web-contacting surface of the paper machine clothing available. It is also possible to provide further non-woven layers, in particular also non-woven layers on the running side facing away from the pulp web.

It may be provided that at least some of the non-woven fibers consist of or have a thermoplastic polymer, in particular a thermoplastic polyurethane.

Other features which are considered as characteristic for the invention are set forth in the appended claims.

Although the invention is illustrated and described herein as embodied in a paper machine clothing, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1A schematically shows a paper machine clothing according to an aspect of variant 1 of the invention;

FIG. 1B schematically shows a base structure according to an aspect of variant 2 of the invention;

FIG. 2A shows a first woven-fabric layer for a base structure according to an aspect of the invention;

FIG. 2B shows a second woven-fabric layer according to a further aspect of the invention.

### DETAILED DESCRIPTION OF THE INVENTION

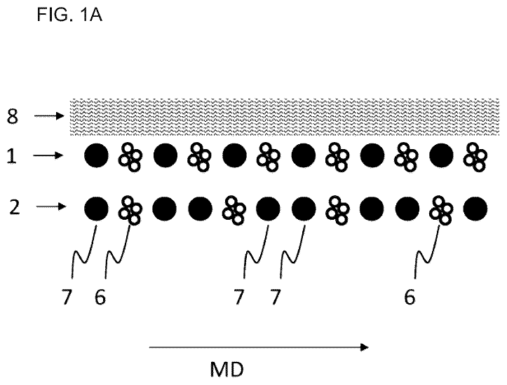

Referring now to the figures of the drawing in detail and first, in particular, to FIG. 1A thereof, there is shown a paper machine clothing formed with a base structure 10 which comprises a first woven-fabric layer 1 and a second woven-fabric layer 2. In this regard, the first woven-fabric layer 1 is arranged above the second woven-fabric layer 2 and in particular constitutes the uppermost woven-fabric layer of the base structure 10.

The paper machine clothing also has a layer of non-woven fibers 8 which is arranged on the top side of the base structure 10. An advantageous material for non-woven fibers may be a thermoplastic polymer, e.g., polyamide. In advantageous embodiments, at least some of the non-woven fibers may also consist of or include a thermoplastic elastomer, for example a thermoplastic polyurethane (TPU).

The first woven-fabric layer 1 and the second woven-fabric layer 2 have both monofilaments 7 and twisted threads 6 as the CD threads 5. These are interwoven with MD threads 4. The latter are not shown in FIG. 1A.

The ratio of twisted threads 6 to monofilaments 7 (twist-to-mono ratio) of the first flat-woven fabric 1 differs from the twist-to-mono ratio of the second flat-woven fabric 2. The twist-to-mono ratio of the first woven-fabric layer 1 in FIG. 1A is “1:1.” This means that in the first woven-fabric layer 1, the same numbers of twists 6 and of monofilaments 7 are used as the CD threads. In this regard, twists 6 and monofilaments 7 are arranged in an alternating manner.

In the second woven-fabric layer 2, the twist-to-mono ratio is less than in the first woven-fabric layer 1. Here, the ratio is “1:2.” Thus, there are two monofilaments 7 for every twisted thread 6.

Although these twist-to-mono ratios may be chosen relatively freely, it is often the case that the twist-to-mono ratio of the first woven-fabric layer 1 is chosen to be in the range between “1:1” and “2:1,” while the twist-to-mono ratio of the second woven-fabric layer 2 is chosen to be between “1:4” and “1:1.”

FIG. 1B shows a base structure 10 according to an aspect of variant 2 of the invention for a paper machine clothing, in particular a press felt for a machine for producing or processing a pulp web. In this regard, the base structure 10 has a first woven-fabric layer 1 and a second woven-fabric layer 2 which are arranged one above the other. In this regard, the first woven-fabric layer 1 is formed of a continuously woven circular-woven fabric, and the second woven-fabric layer 2 is formed of a flat-woven fabric. In this regard, the flat-woven fabric of the second woven-fabric layer 2 is rendered continuous by a connection 3 of its front edges.

In this regard, the connection 3 of the front edges may be realized by a material-fit connection 3 (i.e., material-interlocking, firmly bonded, integrally bonded), for example a welded connection 3. In particular, transmission welding, e.g., NIR transmission welding, is a very advantageous joining method for this purpose.

In this regard, FIG. 1B shows an embodiment in which the first woven-fabric layer 1 is arranged closer to the web-contacting surface of the paper machine clothing than the second woven-fabric layer 2. Alternatively, an inverted arrangement is also possible.

Other than the first woven-fabric layer 1 and the second woven-fabric layer 2, the base structure may also have further constituents. In particular, further woven-fabric layers may be provided, namely circular-woven fabrics and/or flat-woven fabrics.

Alternatively or additionally, the base structure 10 may also comprise constituents that have not been woven, such as, for example, non-woven layers, films, membranes, foam layers, or the like.

In more preferable embodiments, it may be provided that the first woven-fabric layer 1 comprises twisted 6 MD threads 4, while the second woven-fabric layer 2 comprises twisted 6 CD threads 5.

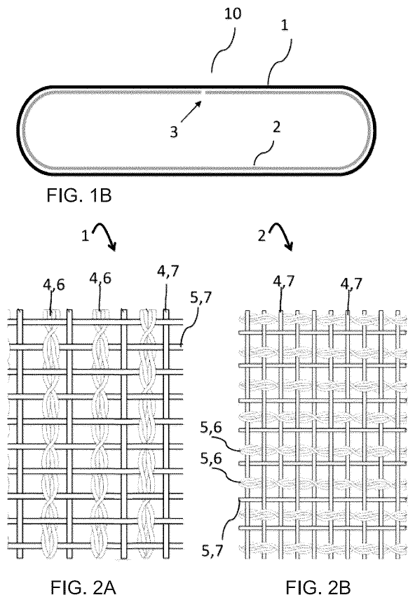

FIGS. 2A and 2B show cutouts from woven-fabric layers 1, 2, such as may be used for a base structure 10 according to aspects of the invention.

The woven fabric of FIG. 2A is provided in particular for a first woven-fabric layer 1. In this woven fabric, the CD threads 5 all consist of monofilaments 7. In the case of the MD threads 4, at least some are designed as twisted MD threads 4, 6, while the remaining MD threads 4 are designed as monofilaments 7. Herein, FIG. 2A shows an embodiment in which 50% of the MD threads 4 are in the form of twisted MD threads 4, 6. In this regard, monofilaments 7 and twists 6 are arranged alternately by way of example. In other embodiments, a larger proportion of twists 6 may also be provided in the first woven-fabric layer 1, for instance at least 75%. It is also possible for all of the MD threads 4 to be in the form of MD threads 4, 6.

The woven fabric of FIG. 2B is provided in particular for a second woven-fabric layer 2. In this woven fabric, the MD threads 4 all consist of monofilaments 7. In the case of the CD threads 5, at least some are designed as twisted CD threads 5, 6, while the remaining CD threads 5 are designed as monofilaments 7. Here, in the second woven-fabric layer 2, 50% of the CD threads 5 are designed as twisted CD threads 5, 6, wherein twisted CD threads 5, 6 and non-twisted CD threads 5, 7 are arranged alternately. Alternatively, it is also possible for less than 50%, for example only 30%, of the CD threads 5 to be designed as twisted CD threads 5, 6. Likewise, a higher proportion of twisted CD threads 5, 6 is possible.

As an example, the twists shown in FIGS. 2A and 2B are produced based on four filaments (4-ply). This may be, for example, 0.2×2×2 or 0.25×2×2 twists. Alternatively, other twists made of more or fewer filaments are also possible.

The following is a summary list of reference numerals and the corresponding structure used in the above description of the invention:

1 First woven-fabric layer
2 Second woven-fabric layer

### 3 Connection

4 MD thread
5 CD thread

### 6 Twist

### 7 Monofilament

8 Layer of non-woven fibers
10 Base structure
MD Machine direction

1. A paper machine clothing, comprising:
a base structure having a first woven-fabric layer and a second woven-fabric layer arranged one above another;
each of said first and second woven-fabric layers having threads in a machine direction (MD) and threads in a cross-machine direction (CD); and
each of said first and second woven-fabric layers having threads being monofilaments and threads being twisted threads.

2. The paper machine clothing according to claim 1, wherein:
said first woven-fabric layer consists of a first flat-woven fabric which is rendered continuous by having front edges thereof connected to one another;
said second woven-fabric layer consists of a second flat-woven fabric which is rendered continuous by having front edges thereof connected to one another;
said first flat-woven fabric and said second flat-woven fabric including CD threads being monofilaments;
said first flat-woven fabric and said second flat-woven fabric including CD threads being twisted threads; and
a ratio of the twisted threads to the monofilaments, being a twist-to-mono ratio, of the first flat-woven fabric differs from a twist-to-mono ratio of the second flat-woven fabric.

3. The paper machine clothing according to claim 1, wherein:
said first woven-fabric layer consists of a first flat-woven fabric which is rendered continuous by connecting front edges thereof; and
said second woven-fabric layer consists of a second flat-woven fabric which is rendered continuous by connecting front edges thereof;
both said first flat-woven fabric and said second flat-woven fabric comprise CD threads being monofilaments;
both said first flat-woven fabric and said second flat-woven fabric comprise CD threads being twisted threads; and
a CD thread density of said first woven-fabric layer is different from a CF thread density of said second woven-fabric layer.

4. The paper machine clothing according to claim 2, wherein the twist-to-mono ratio of said first flat-woven fabric lies between 1:3 and 3:1.

5. The paper machine clothing according to claim 2, wherein the twist-to-mono ratio of said second flat-woven fabric is less than the twist-to-mono ratio of said first flat-woven fabric.

6. The paper machine clothing according to claim 2, wherein the twist-to-mono ratio of said second flat-woven fabric lies between 1:4 and 1:1.

7. The paper machine clothing according to claim 1, wherein said first woven-fabric layer is arranged above said second woven-fabric layer and said first woven-fabric layer constitutes an uppermost woven-fabric layer of said base structure.

8. The paper machine clothing according to claim 1, wherein a CD thread density of said second woven-fabric layer is between 3% and 80% greater than a CD thread density of said first woven-fabric layer.

9. The paper machine clothing according to claim 1, wherein said base structure comprises said first woven-fabric layer, said second woven-fabric layer, and further woven-fabric layers, or said base structure consists of said first woven-fabric layer and said second woven-fabric layer.

10. The paper machine clothing according to claim 2, wherein said first woven-fabric layer and said second woven-fabric layer with a connection point of the front edges of said first flat-woven fabric and a connection point of the front edges of said second flat-woven fabric, viewed in the machine direction, are disposed at a distance of at least 10 cm and at most 3 m.

11. The paper machine clothing according to claim 10, wherein at least one of the connection of the front edges of said first flat-woven fabric or the connection of the front edges of said second flat-woven fabric is a welded connection.

12. The paper machine clothing according to claim 1, wherein said first woven-fabric layer is a continuously woven circular-woven fabric, and said second woven-fabric layer consists of a flat-woven fabric which is rendered continuous by connecting front edges thereof, wherein said first woven-fabric layer comprises twisted MD threads and said second woven-fabric layer comprises twisted CD threads.

13. The paper machine clothing according to claim 12, wherein in said first woven-fabric layer, at least 50% are twisted MD threads.

14. The paper machine clothing according to claim 13, wherein in said second woven-fabric layer, at least 30% of the CD threads are twisted CD threads.

15. The paper machine clothing according to claim 13, wherein in said second woven-fabric layer, 50% of the CD threads are twisted CD threads, and wherein twisted CD threads and non-twisted CD threads are arranged alternately.

16. The paper machine clothing according to claim 12, wherein same twists are used for the twisted MD threads as for the twisted CD threads.

17. The paper machine clothing according to claim 12, wherein different twists are used for the twisted MD threads and the twisted CD threads.

18. The paper machine clothing according to claim 12, where some or all of the twisted MD threads and/or of the twisted CD threads consist of three or more monofilaments.

19. The paper machine clothing according to claim 18, wherein said monofilaments have a diameter of more than 0.15 mm.

20. The paper machine clothing according to claim 1, wherein said first woven-fabric layer is arranged closer to a web-contacting surface of the paper machine clothing than said second woven-fabric layer.

21. The paper machine clothing according to claim 1, wherein said base structure does not have any further woven-fabric layer.

22. The paper machine clothing according to claim 1, further comprising at least one non-woven layer which is fastened to said base structure by needling and which forms a web-contacting surface of the paper machine clothing.

23. The paper machine clothing according to claim 1, further comprising a layer of non-woven fibers arranged on a top side of said base structure, wherein at least some of said non-woven fibers consist of or include a thermoplastic polymer.
